(19) United States
(12) Patent Application Publication
(10) Pub. No.: US 2004/0171730 A1
(43) Pub. Date: Sep. 2, 2004

(54) Polyoxymethylene composition

(75) Inventors: Hanlong Tsai, Fuji-shi (JP); Hiroyuki Hase, Fuji-shi (JP)

Correspondence Address: NIXON & VANDERHYE, PC, 1100 N GLEBE ROAD, 8TH FLOOR, ARLINGTON, VA, 22201-4714, US

(73) Assignee: Polyplastics Co., Ltd., Tokyo (JP)

(21) Appl. No.: 10/733,773

(22) Filed: Dec. 12, 2003

(30) Foreign Application Priority Data
Dec. 26, 2002 (JP) 2002-377701

(51) Int. Cl. C08K 3/18; C08K 5/04

(52) U.S. Cl. 524/430; 524/394

(57) ABSTRACT

The present invention relates to a polyoxymethylene composition that is excellent in heat stability and mold properties (mold release and mold cycle) and can be melt and held in a molding machine with the improved prevention of the resin from color change. The present invention provides the polyoxymethylene composition comprising: a polyoxymethylene; (a) 0.01-3.0% by weight (in the composition, hereinafter likewise) of a steric-hindered phenolic antioxidant; (b) 0.01-1.0% by weight of a compound selected from oxides or carboxylic acid salts of an alkali earth metal; and (c) 0.01-1.0% by weight of an ester of a polyhydric alcohol selected from propylene glycol, trimethylol propane and pentaerythritol and a higher fatty acid (C₈-C₂₉).

### TECHNICAL FIELD TO WHICH THE INVENTION BELONGS

The present invention relates to a polyoxymethylene composition.

### BACKGROUND ART

Polyoxymethylene is produced by polymerizing formaldehyde or trioxane as cyclic oligomers of formaldehyde, or by copolymerizing trioxane with a comonomer such as a cyclic ether or a cyclic formal, and is prevented from suffering decomposition by subjecting the terminal thereof to stabilizing treatment and then, by adding thereto an antioxidant and other heat stabilizer. Steric-hindered phenol compounds or steric-hindered amine compounds have been proposed as the antioxidant to be added to polyoxymethylene, while polyamides, urea derivatives, amidine compounds, and hydroxides of alkali or alkali earth metals have been proposed as other heat stabilizer.

The polyoxymethylene composition comprising these antioxidants or heat stabilizers fundamentally has excellent heat stability or various properties and is utilized in a general molding process or the like without any substantial problems.

As described above, the polyoxymethylene composition conventionally known and available in the market has various excellent properties. However, when melted and molded under severe molding conditions, for example, at a higher temperature or when held within a molding machine cylinder for a long time, the polyoxymethylene composition is affected by heat or oxygen in the molding machine cylinder to cause decomposition of the resin, and as a result, formaldehyde is generated to worsen the working (health) atmosphere or a molded article comprising the polyoxymethylene has turned to be yellow in color due to the reaction of formaldehyde, which may impair its commercial value. Therefore, development of materials which are more improved in heat stability and suppressed in discoloration tendency as much as possible has been desired.

For such a purpose, a composition is known comprising: an oxymethylene copolymer; a polyhydric alcohol fatty acid ester derived from a polyhydric alcohol and a higher fatty acid having a specific number of carbon atoms; and an alkali earth metal salt of a fatty acid having a specific number of carbon atoms (JP-A 4-63857).

Furthermore, a composition is also known comprising: polyoxymethylene; a steric-hindered phenolic antioxidant; and an alkali metal salt and/or alkali earth metal salt of an ester of a polyhydric alcohol monofatty acid ester and phosphorous acid (JP-A 11-60893).

### DISCLOSURE OF THE INVENTION

According to the compositions disclosed in the above-described documents, it is expected that a problem of heat stability or color change in holding is fairly improved.

However, as a result of investigations, the present inventors have found that when using compositions described in JP-A 4-63857 and JP-A 11-60893, sufficient effects on the suppression of color change during holding are not necessarily obtained. For example, even when using a glycerine monofatty acid ester or sorbitan monofatty acid ester which is specifically used in Example of JP-A 4-63857 as a polyhydric alcohol fatty acid ester, satisfactory effects are not obtained.

The present invention is to solve such problems in conventional techniques and to provide a polyoxymethylene composition which is improved in heat stability and more suppressed in occurrence of color change.

In order to solve the above-described problems, the present inventors have made extensive studies on color change of formose which is considered to be produced by the reaction of formaldehyde contained in polyoxymethylene or formaldehyde generated by the decomposition of polyoxymethylene. As a result, the inventors have found that a specific structure of an ester of a polyhydric alcohol and a higher fatty acid is effective in suppressing color change. The present invention has been accomplished based on this finding.

Specifically, the present invention is a polyoxymethylene composition comprising polyoxymethylene, (a) 0.01-3.0% by weight (in the composition, hereinafter likewise) of a steric-hindered phenolic antioxidant; (b) 0.01-1.0% by weight of a compound selected from oxides or carboxylic acid salts of an alkali earth metal and (c) 0.01-1.0% by weight of an ester of a polyhydric alcohol selected from propylene glycol, trimethylol propane and pentaerythritol with a higher fatty acid (C₈-C₂₉).

The present invention is a polyoxymethylene composition that is excellent in heat stability and mold properties (mold release and mold cycle) and can be melt and held in a molding machine with the improved prevention of color change.

### DETAILED DESCRIPTION OF THE INVENTION

The present invention is described in detail below. The polyoxymethylene for use in the present invention is a polymer compound comprising oxymethylene groups (—CH₂O—) as its main constituent unit, which may be any of copolymer, terpolymer and block copolymer containing small amounts of constituent units other than an oxymethylene group in addition to a polyoxymethylene homopolymer. Further, the polyoxymethylene may be one of which the molecule has not only a linear structure but also a branched or cross-linked structure. Further, the degree of polymerization thereof is not also particularly limited.

Next, examples of the steric-hindered phenolic antioxidant (a) to be used in the present invention include 2,2′-methylenebis(4methyl-6-t-butylphenol), 1,6-hexanediol-bis[3-(3,5-di-t-butyl-4-hydroxyphenyl) propionate], pentaerythritol tetrakis[3-(3,5-di-t-butyl-4-hydroxy-phenyl) propionate], triethylene glycol-bis-[3-(3-t-butyl-5-methyl-4-hydroxyphenyl) propionate], 1,3,5-trimethyl-2,4,6-tris(3,5-di-t-butyl-4-hydroxy-benzyl)benzene, n-octadecyl-3-(4′-hydroxy-3′,5′-di-t-butylphenol) propionate, 4,4′-methylenebis(2,6-di-t-butylphenol), 4,4′-butylidene-bis-(6-t-butyl-3-methyl-phenol), di-stearyl-3,5-di-t-butyl-4-hydroxybenzyl phosphonate, 2-t-butyl-6-(3-t-butyl-5-methyl-2-hydroxybenzyl)-4-methylphenyl acrylate, and N,N′-hexamethylenebis(3,5-di-t-butyl-4-hydroxy-hydrocinnamamide). The amount of (a) the steric-hindered phenolic antioxidant added and blended in the present invention is 0.01-3.0% by weight, preferably 0.05-0.5% by weight as a ratio in the polyoxymethylene composition. When the added amount is too small, sufficient effects cannot be obtained, while when it is too large, the effect with respect to heat stability saturates, and if anything, the tendency of color change occurs. Thus, either case is not preferable.

Next, examples of (b) the oxides or carboxylic acid salts of an alkali earth metal to be used in the present invention include magnesium oxide, calcium oxide, calcium stearate and calcium 12-hydroxystearate. The amount of (b) the oxides or carboxylic acid salts of an alkali earth metal to be added and blended in the present invention is 0.01-1.0% by weight, preferably 0.02-0.20% by weight as a ratio in the polyoxymethylene composition.

The present invention is characterized in that the composition prepared by blending the polyoxymethylene with (a) the steric-hindered phenolic antioxidant and (b) the compound selected from oxides or carboxylic acid salts of an alkali earth metal, as described above, is further blended with (c) a specific polyhydric alcohol fatty acid ester, whereby the composition can be melt and held with the extremely noticeably improved prevention of color change of the polyoxymethylene, which is the object of the present invention, and is also improved in heat stability.

The specific polyhydric alcohol fatty acid ester to be used for such a purpose in the present invention is (c) an ester of a polyhydric alcohol selected from propylene glycol, trimethylol propane and pentaerythritol and a higher fatty acid (C₈ to C₂₉). These specific polyhydric alcohol fatty acid esters selectively exert a remarkable effect among a number of generally-known fatty acid esters, specifically, a fatty acid ester of a monohydric alcohol and a fatty acid ester of a polyhydric alcohol. Among these, a propylene glycol monofatty acid ester not only has a remarkable effect on the prevention of color change during melting, holding and the like but also exerts an extremely excellent effect on the mold release during molding and therefore, is particularly preferable.

Furthermore, in view of the prevention of color change during melting, holding and the like, an ester obtained by esterifying 60 mol % or more of the hydroxyl groups of propylene glycol, trimethylol propane and pentaerythritol as an alcohol component constituting an ester by a reaction with a fatty acid is preferable because it exhibits a particularly remarkable effect. Examples of the fatty acid constituting an ester include saturated fatty acids such as pelargonic acid, capric acid, undecanoic acid, lauric acid, tridecyl acid, myristic acid, pentadecyl acid, palmitic acid, margaric acid, stearic acid, nanodecyl acid, arachidic acid, heneicosanoic acid, behenic acid, tricosanoic acid, lignoceric acid, pentacosanoic acid, cerotic acid, heptacosanoic acid, montanic acid, nanocosanoic acid and melissic acid, or unsaturated fatty acids such as oleic acid, linoleic acid and ricinoleic acid.

The added amount of such (c) a component to be used in the present invention is 0.01-1.0% by weight, preferably 0.05-0.5% by weight as a ratio in the polyoxymethylene composition. When the added amount is too small, sufficient effects on the prevention of color change cannot be obtained, while when it is too large, mold properties and heat stability are impaired in some cases. Thus, either case is not preferable.

In the present invention, it is preferable that the polyoxymethylene composition comprising the constituent components as described above is further blended with 0.01-1.0% by weight of (d) a higher fatty acid bisamide compound (for example, ethylenebis-stearamide), whereby the mold properties and the mold release are improved.

In addition, the polyoxymethylene composition of the present invention may be further blended with various commonly known additives. Examples of the additives include nitrogen-containing compounds, various coloring agents, sliding improvers, mold-releasing agents, nuclear agents, antistatic agents, weathering (light) stabilizers, other surfactants and various polymers. Further, one or more of commonly known inorganic, organic, or metal fillers in a form of fiber, plate or powder can be compounded and blended as long as the object of the present invention is not largely impaired. Examples of such inorganic fillers include glass fiber, potassium titanate fiber, glass beads, talc, mica, white mica and wollastonite. However, the present invention is by no means limited thereto.

The polyoxymethylene composition of the present invention can be readily prepared by a commonly known method which is generally used for the preparation method of resin compositions in the conventional art. Any method may be used, for example, a method which comprises mixing every component, kneading and extruding the obtained mixture with a single or twin-screw extruder to prepare pellets; a method which comprises once preparing pellets different in composition, mixing (diluting) the pellets in a predetermined amount and molding the obtained pellet mixture to obtain a molded article having an objective composition after the molding; and a method which comprises feeding one or more of the components directly into a molding machine. Further, a method which comprises pulverizing part or all of the polyoxymethylene as a substrate, mixing the pulverized powder with the rest of the components and extruding the mixture is preferable to improve dispersability of additives in the preparation of such compositions.

The polyoxymethylene composition of the present invention is a very preferable resin composition which is remarkably improved in heat stability and can be melted and held in a molding machine cylinder with the drastically improved prevention of color change of the resin composition.

### EXAMPLES

The present invention is described in detail below by referring to Examples. However, the present invention is not limited thereto. The evaluation method shown in the following examples is as follows.

### <Color Change Degree After Melting and Holding>

From the polyoxymethylene compositions prepared in Examples and Comparative Examples, each of the plain plates having a dimension of 70×50×3 (mm) was molded under two molding conditions shown below. Hue (L, a, b) of respective molded articles was measured using a color sensor Z300A manufactured by Nippon Denshoku Industries Co., Ltd.

### Common Molding Conditions

Injection molding machine: Toshiba IS80EPN

Cylinder temp.: 210° C. (from feeding part to nozzle)

Mold temp.: 92° C.

Injection speed: 1 m/m

### Variable Molding Conditions

Molding conditions 1: Molding was performed at a molding cycle of 40 seconds without allowing the melted resins to be held in a cylinder.

Molding conditions 2: Molding was performed after allowing the melted resins to be held in a cylinder for 30 minutes.

The color change degree (ΔE) after the melting and holding was calculated by using the following expression:

ΔE ={(L₁−L₀)²+(a₁−a₀)²+(b₁−b₀)²}^{1/2}

where, L₁, a₁ and b₁ represent the hue of molded articles according to the molding conditions 2 (after the melting and holding for 30 minutes), and L₀, a₀ and b₀ represent the hue of the molded articles according to the molding conditions 1.

### Examples 1 to 9

(a) A steric-hindered phenolic antioxidant, (b) an alkali earth metal compound and (c) a specific polyhydric alcohol fatty acid ester shown in Table 1 were added to a polyoxymethylene copolymer (Duracon (registered trademark) M90, a product of Polyplastics Co., Ltd.) at a ratio shown in Table 1, followed by mixing. The obtained mixtures were extruded at a resin temperature of 200° C. with a twin-screw extruder to obtain pelletized compositions. The compositions thus prepared were subjected to the above-described evaluation. The results are shown in Table 1.

Incidentally, the composition prepared by using a propylene glycol monofatty acid ester as a polyhydric alcohol fatty acid ester showed particularly excellent mold release during the molding.

### Comparative Examples 1 to 5

For comparison, as shown in Table 2, in the case where the specific polyhydric alcohol fatty acid ester (c) specified in the application was not added, in the case where a fatty acid ester different from the specific polyhydric alcohol fatty acid ester (c) specified in the application was added, and the like, pelletized compositions were prepared in the same manner as in the Examples. The thus prepared compositions were subjected to the above-described evaluation. The results are shown in Table 2.

Incidentally, compositions were similarly prepared also in the case where no polyhydric alcohol fatty acid ester was added, or also in the case where a monohydric alcohol fatty acid ester was added. However, the compositions were deteriorated in mold release and the like during the molding and not preferable in view of molding cycle.

(a) The steric-hindered phenolic antioxidants, (b) the oxides or carboxylic acid salts of an alkali earth metal, and (c) the specific polyhydric alcohol fatty acid esters, which were used in Examples and Comparative Examples, and (c′) the fatty acid esters which were used as Comparative Examples, were as follows.

(a) steric-hindered phenolic antioxidants

a; triethylene glycol bis[3-(3-t-butyl-5-methyl-4-hydroxyphenyl) propionate

(b) oxides or carboxylic acid salts of an alkali earth metal

b-1; magnesium oxide

b-2; calcium 12-hydroxystearate

(c) specific polyhydric alcohol fatty acid esters specified in the present invention

c-1; propylene glycol distearate

c-2; trimethylol propane distearate

c-3; trimethylol propane tristearate

c-4; pentaerythritol distearate

c-5; pentaerythritol tristearate

c-6; pentaerythritol tetrastearate

c-7; propylene glycol monostearate

(c′) fatty acid esters not falling under the specification of the present invention

c′-1; glycerine monostearate

c′-2; glycerine distearate

c′-3; sorbitan stearate

c′-4; sorbitan tristearate

c′-5; ethylene glycol dimontanate

(d) higher fatty acid bisamide compounds

d; ethylenebis-stearamide

(e) nitrogen-containing compounds

e; melamine-formaldehyde polycondensates prepared by a commonly known method, wherein the number of moles of the formaldehyde charged is 1.2 based on one mole of the melamine.

TABLE 1

| | Examples | | | | | | | | |
|---|---|---|---|---|---|---|---|---|---|
| | 1 | 2 | 3 | 4 | 5 | 6 | 7 | 8 | 9 |
| Steric-hindered phenolic | a | a | a | a | a | a | a | a | a |
| antioxidant (% by weight) | 0.30 | 0.30 | 0.30 | 0.30 | 0.30 | 0.30 | 0.30 | 0.30 | 0.30 |
| Metal compound | b-1 | b-1 | b-1 | b-1 | b-1 | b-1 | b-1 | b-1 | b-1 |
| (% by weight) | 0.03 | 0.03 | 0.03 | 0.03 | 0.03 | 0.03 | 0.03 | 0.03 | 0.03 |
| | | | | | | | | b-2 | b-2 |
| | | | | | | | | 0.01 | 0.01 |
| Fatty acid ester | c-1 | c-2 | c-3 | c-4 | c-5 | c-6 | c-7 | c-7 | c-4 |
| (% by weight) | 0.25 | 0.25 | 0.25 | 0.25 | 0.25 | 0.25 | 0.25 | 0.05 | 0.05 |
| Nitrogen-containing | e | e | e | e | e | e | e | e | e |
| compound (% by weight) | 0.10 | 0.10 | 0.10 | 0.10 | 0.10 | 0.10 | 0.10 | 0.20 | 0.20 |
| Fatty acid bisamide | | | | | | | | d | d |
| (% by weight) | | | | | | | | 0.20 | 0.20 |
| Color change degree | 0.26 | 0.30 | 0.29 | 0.57 | 0.52 | 0.49 | 0.46 | 0.60 | 0.58 |
| after melting and holding | | | | | | | | | |

TABLE 2

| | Comparative Examples | | | | |
|---|---|---|---|---|---|
| | 1 | 2 | 3 | 4 | 5 |
| Steric-hindered phenolic | a | a | a | a | a |
| antioxidant (% by weight) | 0.30 | 0.30 | 0.30 | 0.30 | 0.30 |
| Metal compound | b-1 | b-1 | b-1 | b-1 | b-1 |
| (% by weight) | 0.03 | 0.03 | 0.03 | 0.03 | 0.03 |
| Fatty acid ester | C′-1 | C′-2 | C′-3 | C′-4 | C′-5 |
| (% by weight) | 0.25 | 0.25 | 0.25 | 0.25 | 0.25 |
| Nitrogen-containing | e | e | e | e | e |
| compound (% by weight) | 0.10 | 0.10 | 0.10 | 0.10 | 0.10 |
| Fatty acid bisamide | | | | | |
| (% by weight) | | | | | |
| Color change degree | 2.39 | 1.34 | 5.7 | 2.43 | 2.49 |
| after melting and holding | | | | | |

1. A polyoxymethylene composition comprising polyoxymethylene, (a) 0.01-3.0% by weight (in the composition, hereinafter likewise) of a steric-hindered phenolic antioxidant, (b) 0.01-1.0% by weight of a compound selected from the group consisting of oxides or carboxylic acid salts of an alkali earth metal and (c) 0.01-1.0% by weight of an ester of a polyhydric alcohol selected from the group consisting of propylene glycol, trimethylol propane and pentaerythritol with a higher fatty acid (C₈-C₂₉).

2. The composition according to claim 1, wherein said ester (C) is a monofatty acid ester of propylene glycol.

3. The composition according to claim 1, wherein said ester (C) is an ester in which at least 60 mol % of hydroxy groups of the polyhydric alcohol has been esterified.

4. The composition according to any of claims 1 to 2, further comprising (d) 0.01-1.0% by weight of a higher fatty acid bisamide compound.
